(19) United States
(12) Patent Application Publication
(10) Pub. No.: US 2002/0000275 A1
(43) Pub. Date: Jan. 3, 2002

(54) Method for equalizing radial and lateral force variations at the tire/road footprint of a pneumatic tire

(76) Inventor: Robert D. Fogal SR., Chambersburg, PA (US)

Correspondence Address: OLDHAM & OLDHAM CO, TWIN OAKS ESTATE, 1225 W MARKET STREET, AKRON, OH, 44313, US

(21) Appl. No.: 09/923,904

(22) Filed: Aug. 7, 2001

Related U.S. Application Data
(63) Continuation of application No. 09/495,521, filed on Jan. 31, 2000.
(60) Provisional application No. 60/133,774, filed on May 12, 1999.

(51) Int. Cl. F16F 15/32

(52) U.S. Cl. 152/154.1; 156/394.1

(57) ABSTRACT

A method and composition for equalizing radial and lateral forces at the tire/road footprint of a pneumatic tire due to tire/wheel assembly imbalance, non-uniformity of the tire, temporary disturbances in the road surface, or other vibrational effects of the unsprung mass of a vehicle by balancing the tire and inserting a particle mixture into the interior of the tire. The composition used therefor is a dry solid particle mixture wherein the particles are freely flowable and non-tacky at temperatures up to 150° C. The particle mixture is essentially devoid of liquid material, stable and remains free flowing over all conditions of tire usage, has a specific gravity greater than 1, and is available in the particle sizes of 20-200 mesh size, and has sufficient hardness to withstand the repeating tumbling which will occur in a vehicle tire without substantial abrasion.

### FIELD OF THE INVENTION

This invention relates to reducing disturbances in the unsprung mass of a vehicle and particularly to a method for compensating for radial and lateral force variations at the tire/road footprint of a pneumatic tire of a vehicle. Such disturbances are due to tire/wheel assembly imbalance, non-uniformity of the tire, temporary disturbances in the road surface, or other vibrational effects of the unsprung mass of a vehicle.

### BACKGROUND OF THE INVENTION

A typical motor vehicle is generally characterized as comprising an unsprung mass and a sprung mass. The unsprung mass generally consists of all of the parts of the vehicle not supported by the vehicle suspension system such as the tire/wheel assembly, steering knuckles, brakes and axles. The sprung mass, conversely is all of the parts of the vehicle supported by the vehicle suspension system. The unsprung mass can be susceptible to disturbances and vibration from a variety of sources such as worn joints, misalignment of the wheel, brake drag, irregular tire wear, etc. Because vehicular tires support the sprung mass of a vehicle on a road surface and such tires are resilient, any irregularities in the uniformity or dimensions of the tire, any dimensional irregularities in the wheel rim, and/or any dynamic imbalance or misalignment of the tire/wheel assembly will cause disturbances and vibrations to be transmitted to the sprung mass of the vehicle thereby producing an undesirable or rough vehicle ride, as well as reducing handling and stability characteristics of the vehicle. Severe vibration can result in dangerous conditions such as wheel tramp or hop and wheel shimmy (shaking side-to-side).

It is now standard practice to reduce some of these adverse vibrational effects by balancing the wheel rim and tire assembly by using a balance machine and clip-on lead weights. The lead balance weights are placed on the rim flange of the wheel and clamped in place in a proper position as directed by the balancing machine. The balancing procedure can reduce imbalance in the tire/wheel assembly; however, perfect balance is rarely achieved. Balancing is not an exact art and the results are dependent upon the specific set up of a tire/wheel assembly on a specific balancer at that moment in time. Balancing is an improvement and will reduce the vibration of the tire/wheel assembly in comparison to an unbalanced tire/wheel assembly. However, even perfect balancing of the tire/wheel assembly does not necessarily mean that the tire will roll smoothly. The balancing of the tire/wheel assembly must necessarily be done in an unloaded condition. When the balanced tire is placed on the vehicle, the weight of the vehicle acts on the tire through the interface or contact area of the tire and the road surface, which is commonly known, as the tire footprint. Irregularities in the tire are common such that even a perfectly balanced tire can have severe vibrations due to non-uniformities in the tire which result in unequal forces within the tire footprint.

A level of non-uniformity is inherent in all tires. In the art of manufacturing pneumatic tires, rubber flow in the mold or minor differences in the dimensions of the belts, beads, liners, treads, plies of rubberized cords or the like, sometimes cause non-uniformities in the final tire. When non-uniformities are of sufficient magnitude, they will cause force variations on a surface, such as a road, against which the tires roll and thereby produce vibrational and acoustical disturbances in the vehicle upon which the tires are mounted. Regardless of the cause of the force variations, when such variations exceed the acceptable minimum level, the ride of a vehicle utilizing such tires will be adversely affected.

Non-uniformity is generally characterized as 1) radial runout or out-of-roundness, 2) radial force variations, and 3) lateral force variations or conicity. Radial runout is the deviation from perfect roundness of the outer circumference of the tire. For example, the beads of the tire may be not exactly concentric relative to the axis of rotation of the tire or the tread may not be concentric with the beads. Radial force variation is the deviation from spindle load transmitted by a perfect tire during rotation. For example, radial force anomalies in a tire may result from “hard” and/or “soft” spots in the tire due to structural non-uniformities, such as inconsistent wall thickness, ply turn-up variations, bead set, ply arrangement and other deviations. Lateral force variation is the deviation from straight tracking during rotation of the tire. For example, lateral force variations can result if the belt package of the tire is axially displaced or conically shaped. While lateral force variations will tend to pull the vehicle to a side of the road, it is primarily the radial force variations, including radial run-out, resulting in the vibration and acoustical effects which degrade the ride of the vehicle.

In a non-uniform tire, the radial run-out, the radial forces, and the lateral forces exerted by the tire will vary or change during its rotation. In other words, the magnitude and/or direction of the radial run-out, and the radial and lateral forces exerted by the tire will depend on which increment of its tread is contacting the surface.

Accordingly, methods have been developed to correct for excessive force variations by removing rubber from the shoulders and/or the central region of the tire tread by means such as grinding. Most of these correction methods include the steps of indexing the tire tread into a series of circumferential increments and obtaining a series of force measurements representative of the force exerted by the tire as these increments contact a surface. One such uniformity characteristic test, which is generally performed on the tire, is a test for radial force variation. Radial force variation is typically expressed as a variation in the force against the test wheel, which is sensed during rotation of the tire. Radial force variation can be represented by a combination of first harmonic radial force variation through an nth harmonic radial force variation or a composite radial force variation. The nth harmonic is the last harmonic in a Fourier Series analysis of the composite radial force variation which is deemed acceptable to accurately define the radial force variation. It is known in the tire and automobile industries that vehicle ride is generally most affected by the first harmonic radial force variation of the tire. The first harmonic radial force variation is often associated with the radial run-out of the tire. This data is then interpreted and rubber is removed from the tire tread in a pattern related to this interpretation. These methods are commonly performed with a force variation or uniformity machine, which includes an assembly for rotating a test tire against the surface of a freely rotating loading drum. This arrangement results in the loading drum being moved in a manner dependent on the forces exerted by the rotating tire whereby forces may be measured by appropriately placed measuring devices. A computer interprets the force measurements and grinders controlled by the computer remove rubber from the tire tread. However, grinding of the tire has certain disadvantages. For example, grinding can reduce the useful tread life of the tire, it may render the tire visually unappealing or it can lead to the development of irregular wear when the tire is in service on a vehicle.

While uniformity machines have been relatively successful in reducing the undue vibrations transmitted to the sprung mass of the vehicle by the tires, their complexity, manufacturing cost, and the requirement of trained operating personnel has limited the use of these devices primarily to the manufacturing facilities of the vehicle tire manufacturing companies. This has resulted in improved ride characteristics with respect to the original equipment tires on the vehicle but has done little to maintain the original improved ride characteristics when these original equipment tires are worn or replaced with after market replacement tires. Further, the methods used in uniformity testing usually mount the tire on an axle or arbor for testing rather than on the vehicular wheel rim. Because the wheel rim itself can have dimensional inaccuracies which affect uniformity, and the remainder of the unsprung mass of the vehicle can also adversely affect uniformity characteristics, correcting the tires with force variation tire grinding without the tire being mounted on the wheel rim and vehicle on which it is to be used will fail to compensate for the total irregularities of the tire/wheel assembly. Furthermore, these characteristics can change as the tire is worn due to uneven or irregular wear and also normal wear progression.

Balancing of the tires has also been accomplished by using methods other than balance machines and lead weights. For example, Fogal in U.S. Pat. No. 5,073,217 disclosed a method of balancing a vehicle tire/wheel assembly by introducing a pulverulent synthetic plastic material into the interior chamber of the tire wheel assembly. The pulverulent synthetic plastic material has the added effect of compensating for the radial and lateral force variations generated at the tire road interface. The movement of the pulverulent synthetic plastic material within the tire is proportional to the downward force of the vehicle weight and the centrifugal force due to the tire rotation. While the invention disclosed in U.S. Pat. No. 5,073,217 worked effectively on truck tires having a large gross vehicle weight (GVW), the 20-40 mesh size pulverulent synthetic plastic material was found to not work as effectively for passenger type vehicles. The reason for the different performance is that the passenger vehicles have a significantly lower GVW. The movement of the inserted particles is directly related to the downward force on the tire. The weight of a typical passenger vehicle is not sufficient to move the 20-40 mesh pulverulent synthetic plastic material properly within the passenger tire and was thus unable to effectively balance the radial and lateral forces. The use of a 20-40 mesh pulverulent synthetic plastic material was found to not be adequate to overcome both the uniformity problems within the tire and the effects due to imbalance of the tire/wheel assembly.

Therefore, there remains a need in the art for an improvement in reducing non-uniformities in the unsprung mass of a vehicle, including radial and lateral force variations at the tire footprint due not only to tire/wheel assembly imbalance, but also reducing force variations from other causes as well.

### SUMMARY OF THE INVENTION

An object of this invention is to overcome the deficiencies and disadvantages of the prior art, and provide a method for compensating for and reducing vibrations caused by radial and lateral forces at the tire/road footprint of a pneumatic tire due to tire/wheel assembly imbalance, non-uniformity of the tire, temporary disturbances in the road surface, or other vibrational effects of the unsprung mass of a vehicle.

A further object of this invention is to enable effective compensation of such radial and lateral force variations on a continuous basis during operation of a vehicle and to extend the tread life of the vehicle tire.

To accomplish these and other objects of the invention, a method of compensating for vibrations caused by radial and lateral force variations at the tire/road footprint of a pneumatic tire on a vehicle comprising the steps of providing a tire/wheel assembly for use on a vehicle. Thereafter, the method of the invention provides for the steps, without limitation to order, of balancing the tire/wheel assembly using a conventional tire balancer and providing a flowable material which is stable and capable of flowing at elevated temperatures within the tire in the tire/wheel assembly. The material has a specific gravity greater than 1 so as to be movable within the tire in response to radial and lateral force variations during tire rotation. As such, upon rotation of the tire/wheel assembly, radial and lateral force variations move the flowable material to positions which reduces the radial and lateral force variations at the tire/road footprint.

In accordance with the preferred method of the present invention, a tire/wheel assembly is balanced using a standard wheel balancer utilizing clip-on weights or the like. In addition, a specified amount of a flowable material is inserted into the tire. The combination of the optimized amount of the flowable material and the benefits of tire balancing using lead weights are combined to reduce vibration attributed to tire/wheel imbalance, but also reduces vibration caused by excessive radial run-out, radial and lateral force variation and other vibrational effects of the unsprung mass of a vehicle.

The movable material according to a preferred embodiment is a composition of dry, solid particle mixtures in which the particles are freely flowable and non-tacky at elevated temperatures within the tire. Preferred compositions or particle mixtures according to this invention include a desired particle size distribution for correcting tire imbalance and non-uniformities of a tire/wheel assembly in association with a given tire/wheel assembly and vehicle. The nature, size and quantity of the particle mixture are determined by the characteristics of the tire/wheel assembly and/or the characteristics of the vehicle (such as GVW). The tire-to-road impact forces the particle mixture proportionately toward such areas to null or eliminate radial force variation and achieve load force equalization. In other words, an amount of the particle mixture is forced to areas opposite the impact and load forces, both sidewall-to-sidewall across the footprint of the tread and, of course, circumferentially about the tire. In this fashion irrespective of the specific load force at any point between tire and surface, eventual continuous tire rotation and tire load force variation results in displacement of the particle mixture to minimize radial and lateral force variations, thereby placing the tire/wheel assembly in a force equalized condition. The aforesaid force equalizing is desirably achieved instantaneously, and in the preferred embodiment, the particle mixture is relatively light and thus “moves” rapidly under variable load forces.

With the above, and other objects in view that will hereinafter appear, the nature of the invention will be more clearly understood by reference to the following detailed description, the appended claims and the several views illustrated in the accompanying drawings.

### BRIEF DESCRIPTION OF THE DRAWINGS

FIG. 1 shows a single wheel model of a vehicle showing the relationship of the sprung mass and the unsprung mass;

FIG. 2 is a fragmentary side elevational view of a conventional tire/wheel assembly including a tire carried by a rim, and illustrates a lower portion or “footprint” of the tire tread resting upon and bearing against an associated supporting surface, such as a road;

FIG. 3 is an axial vertical cross sectional view of a conventional rear position unsprung mass of vehicle including the tire/wheel assembly of FIG. 2 and additionally illustrates the lateral extent of the footprint when the tire rests under load upon the road surface;

FIG. 4 is a cross sectional view of the tire/wheel assembly of FIG. 3 during rotation, and illustrates a plurality of radial load forces of different variations or magnitudes reacting between the tire and the road surface as the tire rotates, and the manner in which the particle mixture is forced in position in proportion to the variable radial impact forces;

FIG. 5 is a graph, and illustrates the relationship of the impact forces to the location of the particle mixture relative to the tire when under rolling/running conditions during equalizing in accordance with FIG. 4.; and

FIG. 6 is a somewhat schematic representation of a method for compensating for radial and lateral force variations according to a preferred embodiment.

### DETAILED DESCRIPTION OF THE DRAWINGS

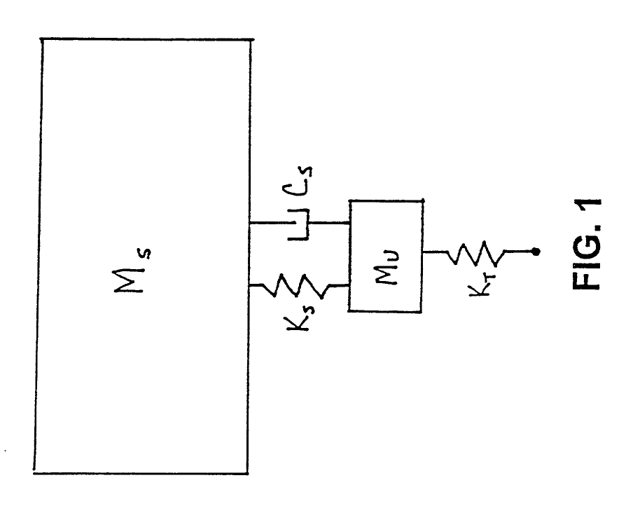

Reference is first made to FIG. 1 of the drawings which shows a single wheel model of a vehicle where symbol Ms denotes the mass of a sprung vehicle structure (hereafter referred to as sprung mass) and Mu denotes the mass of an unsprung structure (hereafter referred to as unsprung mass). The unsprung mass Mu generally consists of all of the parts of the vehicle not supported by the vehicle suspension system such as the tire/wheel assembly, steering knuckles, brakes and axles. The sprung mass Ms, conversely is all of the parts of the vehicle supported by the vehicle suspension system. Symbol Ks denotes the spring constant of a vehicle spring, and Cs denotes the damping force of the shock absorber. The unsprung mass Mu can be susceptible to disturbances and vibration from a variety of sources such as worn joints, misalignment of the wheel, brake drag, irregular tire wear, etc. The vehicular tires are resilient and support the sprung mass Ms of a vehicle on a road surface as represented by the spring rate of the tires as symbol Kt. Any irregularities in the uniformity or dimensions of the tire can result in a variable spring rate Kt which, as the tire rotates, can cause vibration of the unsprung mass Mu which is transmitted to the sprung mass Ms. In addition, any dimensional irregularities in the wheel rim, and/or any dynamic imbalance or misalignment of the tire/wheel assembly will cause disturbances and vibrations to be transmitted to the sprung mass Ms of the vehicle thereby producing an undesirable or rough vehicle ride, as well as reducing handling and stability characteristics of the vehicle.

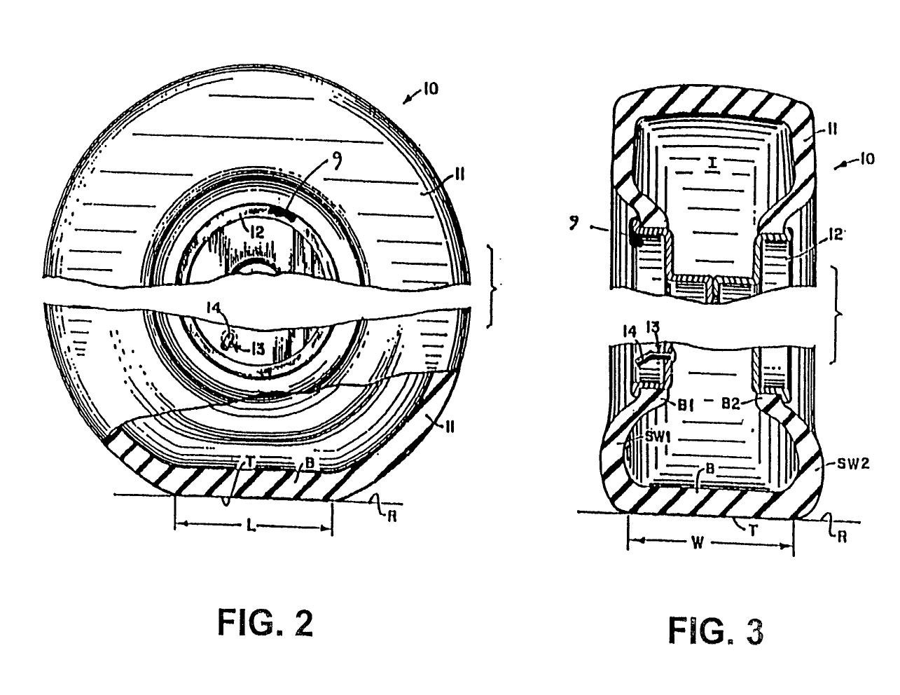

Referring now to FIGS. 2 and 3 of the drawings, which illustrate a tire/wheel assembly 10, that is an element of the unsprung mass Mu referred to in FIG. 1. A tire 11 and a metal rim 12 carrying a tire inflation valve 13 define the tire/wheel assembly 10. In the preferred method according to the invention, the tire wheel assembly 10 is balanced preferably by using standard lead weights 9 or other weight adjusting devices or means such as lead tape, rubber patches or removal of tire material could be used. The lead weights 9 are positioned on the wheel rim 12 as designated by a standard balance machine (not shown) as is well known in the art. Balancing of assembly 10 is typically accomplished by using a two plane balance where the weights 9 are placed on both sides of the wheel rim 12 if necessary to balance the tire/wheel assembly 10. Balancing can also be accomplished using a single plane balance where balance weights 9 are only attached to the inboard side of the wheel rim 12 such that they are hidden from view. This is commonly done on expensive wheel rims where the owner does not want the aesthetics of the wheel diminished by lead weights. The tire 11 is typically a radial tire, as compared to a biased tire, which essentially does not flex radially. A radial tire tends to flex radially, and in use the latter can be evidenced by sidewalls SW1, SW2 (FIGS. 2, 3, and 4) which tend to bulge outwardly under load when resting or running upon a surface, such as a road R. The amount of flex will vary depending upon such things as the tire construction, proper tire inflation, total load of the vehicle, the speed of the vehicle, etc., and the load force can vary from wheel assembly to wheel assembly both in smaller passenger vehicles and larger passenger vehicles, such as sports utility vehicles.

The radial tire 11 includes a lower tire portion or a footprint B defined by a length L and a lateral breadth or width W which collectively define the instantaneous cross sectional area of the tire footprint B in engagement with the supporting surface or road R when the tire/wheel assembly 10 is stationary or is rotating. The tire T includes a conventional external tire tread T and beads B1, B2 of the respective sidewalls SW1, SW2, which engage the rim 12 in a conventional manner.

If the tire/wheel assembly 10 and similar tire/wheel assemblies associated with a vehicle (not shown) are not properly/perfectly balanced, the attendant unbalanced condition thereof during vehicle wheel rotation will cause the tires to wear unevenly, wheel bearings will wear excessively, shock absorbers operate at inordinately higher amplitudes and speeds, steering linkages/mechanisms vibrate excessively and become worn and overall vehicle ride is not only rough and dangerous, but also creates excessive component wear of the entire vehicle. As previously mentioned, even if the tire/wheel assembly 10 was balanced as perfectly as possible with lead weight 9, other problems associated with the unsprung mass Mu such as non-uniformities in the tire, drag from the brakes, worn linkages, changing road conditions, tire wear, vehicle weight changes, etc., can cause even the “perfect” balanced tire/wheel assembly 10 to have vibrational problems. Accordingly, the present invention provides not only for balancing of the tire/wheel assembly 10 to get the tire/wheel assembly closer to an acceptable running condition, but also the use of a flowable material inside the tire to equalize radial and lateral force variations which constantly change in response to variations in road conditions, load forces, changes in speed, etc. Thus, as forces vary during rotation of the tire/wheel assembly 10 relative to the road R, the tire must not only be balanced but the force variations must be equalized and the response time for such force variation equalization is desired to be virtually instantaneous irrespective of the tire-to-road force and/or amplitude.

In keeping with a preferred embodiment of the present invention, equalizing of radial and lateral forces at the tire/road footprint B of a pneumatic tire 11 due to non-uniformity of the tire, temporary disturbances in the road surface, or other vibrational effects of the unsprung mass Mu of a vehicle is accomplished by a combination of balancing the tire/wheel assembly 10 and inserting a predetermined amount of a flowable material 20 into the interior of the tire 11 of the tire/wheel assembly 10. A predetermined amount/weight of the material 20 can be placed in the interior I of the tire 11 prior to the tire 11 being mounted upon the rim 12. However, it is also possible to inject the flowable material 20 into the tire interior I after the tire 11 has been mounted on the rim 12, through the tire valve or air valve 13. Both methods are shown and described in U.S. Pat. No. 5,073,217, which is hereby incorporated by reference. An alternate method is shown in U.S. patent application Ser. No. 09/310,594, entitled, Method and System for Tire/Wheel Disturbance Compensation, which is hereby incorporated by reference. The tire can be balanced either before or after the flowable material 20 is placed into tire 11 as the flowable material 20 has no detrimental effect on the balancing procedure. This is due to the fact that the tire 11 is unloaded. The flowable material 20 evenly distributes in the tire interior I such that any inherent imbalance in the tire/wheel assembly 10 is unchanged. However, in the preferred embodiment, it is possible to optimize the amount of material 20 used within the tire 11 according to the amount of balance weights 9 used to balance the tire/wheel assembly 10. For example, if more than a specified total weight of balance weights 9 are necessary to balance a tire/wheel assembly 10, then an additional amount of material 20 can be used to optimize the reduction of radial and lateral force variations at the tire/road footprint. Conversely, if less than a specified total weight of balance weights 9 is necessary to balance a tire/wheel assembly 10, then a lesser amount of material 20 can be used to optimize performance. This process is, of course, repeated with each tire of each tire/wheel assembly 10 of the particular vehicle involved, and once completed the vehicle is then merely driven along the road R whereupon each tire/wheel assembly 10 is rotated and the force variations are substantially equalized.

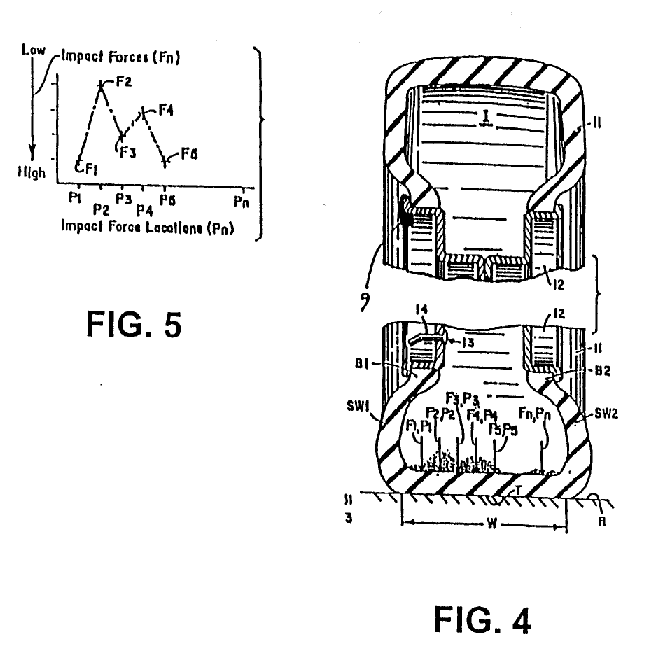

Reference is made to FIGS. 4 and 5 which illustrate the innumerable radial impact forces (Fn) which continuously react between the road R and the tread T at the lower portion or footprint B during tire/wheel assembly rotation. There are an infinite number of such forces Fn at virtually an infinite number of locations (Pn) across the lateral width W and the length L of the footprint B, and FIGS. 4 and 5 diagrammatically illustrate five such impact forces F1-F5 at respective locations P1-P5. As is shown in FIG. 5, it is assumed that the forces F1-F5 are different from each other because of such factors as tire wear at the specific impact force location, the road condition at each impact force location, the load upon each tire/wheel assembly, etc. Thus, the least impact force is the force F1 at location P1 whereas the greatest impact force is the force F2 at location P2. Once again, these forces F1-F5 are merely exemplary of innumerable/infinite forces laterally across the tire 11 between the sidewalls SW1 and SW2 and circumferentially along the tire interior I which are created continuously and which vary as the tire/wheel assembly 10 rotates.

As these impact forces are generated during tire/wheel assembly rotation, the material 20 is adapted to relocate in dependency upon the location and the severity of the impact forces Fn. In the preferred embodiment, material 20 is a composition of dry, solid particles, wherein relocation of the particle mixture 20 through movement of the individual granules, powder and dust is also inversely related to the magnitude of the impact forces. For example, the greatest force F1 (FIG. 5) is at position P1, and due to these greater forces F1, the particle mixture 20 is forced away from the point P1 with the least amount of the particle mixture remaining at the point P1 because the load force there is the highest. Contrarily, the impact force F is the lowest at the impact force location point P2 and therefor more of the particle mixture 20 will remain there (FIG. 4). In other words, at points of maximum or greatest impact forces (F1 in the example), the quantity of the particle mixture 20 is the least, whereas at points of minimum force impact (point P2 in the example), the quantity of particle mixture 20 is proportionately increased. This movement of material creates lift, thereby substantially equalizing the radial and lateral force variations. Accordingly, the vibrations or impact forces Fn force the particle mixture 20 to continuously move away from the higher or excessive impact areas F1 or areas of maximum imbalance F1 and toward the areas of minimum impact forces or imbalance F2. The particle mixture 20 is moved by these impact forces Fn both laterally and circumferentially, but if a single force and a single granule of the particle mixture 20 could be isolated, so to speak, from the standpoint of cause and effect, a single granule located at a point of maximum impact force Fn would be theoretically moved 180 degrees therefrom. Essentially, with an adequate quantity of particle mixture 20, the variable forces Fn create through the impact thereof a lifting effect within the tire interior I which equalizes the radial force variation applied against the footprint until there is a total force equalization circumferentially and laterally of the complete tire/wheel assembly 10. Thus the rolling forces created by the rotation of the tire/wheel assembly 10 in effect create the energy or force Fn which is utilized to locate the particle mixture 20 to achieve lift and force equalization and assure a smooth ride. Furthermore, due to the characteristics of the particle mixture 20, road resonance is absorbed as the tire/wheel assemblies 10 rotate.

Referring now to the preferred particle mixture 20, the compositions according to the present invention are dry solid particle mixtures in which the particles are stable, freely flowable and non-tacky at temperatures up to 150° C. (300° F.). This temperature is above the highest operating temperature in a tire under normal conditions. The particle mixture is preferably essentially devoid of liquid material, since the presence of liquid may interfere with free movement or tumbling of particles which provides a desired mechanism to compensate for radial and lateral force vibrations. Any particulate material that is stable and remains free flowing over all conditions of tire usage, has a specific gravity greater than 1, and is available in the particle sizes to be discussed below, can be used. These materials include, but are not limited to glass beads and/or metallic spheres and may also be combined with lubricating materials such as talc, vermiculite, or silica. Alternatively, although not preferred, the material 20 could be provided in a flowable liquid or paste-like form, or any other suitable form with the characteristics of being flowable in the operating conditions of the tire/wheel assembly 10 and having a specific gravity of greater than 1. An important requirement is that the particulate material must be more thermally stable than the tire in which it is used under all tire operating conditions. Another characteristic of composition according to this invention is the particles comprising the composition should have hardness sufficient to withstand the repeating tumbling that will occur in an automobile tire without substantial abrasion

A particle mixture according to the preferred embodiment of this invention may consist essentially of particles which are of regular shape (e.g., spheres or ellipsoids), preferably regular size and shape; or particles of irregular size and shape, e.g., pulverulent material (granules, powder or dust); or which may comprise a mixture of the two. Particles according to the present invention are preferably polymeric (plastic) although materials such as glass beads and/or metallic particles are also contemplated. Polymeric materials are for the most part organic. Organic polymeric materials for the practice of this invention may be either homopolymers (polymers of one monomer) or copolymers (polymers of two or more monomers). Polymeric materials may be either thermoset or thermoplastic. Suitable thermoset materials include urea formaldehyde, melamine formaldehyde, phenolic, or epoxy, to name a few of such materials. The thermoset resins described herein are available as molding powders, which typically include a major amount of the resin, a minor amount of a filler or fillers, and optionally small amounts of other ingredients. Suitable thermoplastics for particles according to the present invention include nylon and polyester (e.g., polyethylene terephthalate (or PET)). All of these materials are well known in particle form. Thermoset materials are inherently dry and non-melting. Thermoplastic materials in accordance with the present invention are those which have melting points (or softening points) above 150° C. (300° F.).

The optimum amount (or weight) of particle mixture per tire to be used will vary over a wide range, depending on the size of the tire, the GVW, and amount of the tire is out of balance or other factors, whether this amount be expressed as a suitable range or as a optimum amount. For example, the preferred amount for passenger and light truck vehicles is in a range of 0.25-2.0 ounces while larger vehicles may use a much larger amount. In addition, the optimum size or size distribution of the particles in the composition will vary as well. Compositions with smaller particles are preferred for lighter weight vehicles as they will respond to smaller forces and move more quickly to a position opposite the force. The larger particles add stability and react to larger forces. For example, the preferred particle sizes for passenger and light truck vehicles are in a range of 60-80 mesh size or particles less than 60 mesh size. Other preferred formulations include fiberglass particles of 140-170 mesh size while larger vehicles may use a larger range preferably about 20-40 mesh size. A table showing the preferred amount of 60-80 mesh size particle mix and talc for different tire wheel sizes is shown below. The material amounts are given as a nominal value with a plus or minus tolerance and the talc is given as a range and generally represents 20-30% of the material amount:

Preferred Amount of 60-80 Mesh Size Pulverulent Synthetic
Plastic Material and Talc for Passenger and Light Truck Tires

| TIRE WHEEL | AMOUNT OF | AMOUNT OF |
|---|---|---|
| SIZE | MATERIAL (oz.) | TALC (oz.) |
| 13″ | 0.4 ± 0.2 | 0.1-0.2 |
| 14″ | 0.7 ± 0.3 | 0.2-0.3 |
| 15″ | 1.1 ± 0.4 | 0.2-0.4 |
| 16″ | 1.3 ± 0.4 | 0.2-0.5 |
| 17″ | 1.5 ± 0.5 | 0.3-0.6 |

As such it may be possible to use particles smaller than 200 mesh which would move in response to smaller forces. In addition, the particle mixture may include a particle distribution including very fine materials such as talc, which attach to the tire innerliner surface and the individual particles of the particle mixture. The talc or like material also acts as an anti-agglomeration agent to keep particles separate and free flowing. The increased lubricity and smaller particle size result in decreased response time for movement of the particle mixture and also allows the particle mixture to more readily disperse under the lower vehicle GVW condition of passenger cars and light trucks. Another possible improvement is to use particles that are polymodal. That is, a plot of weight fraction vs. particle diameter will show two or more particle sizes or particle size ranges having relatively high concentration of particles, separated by a region of particle size range in which there are no particles or few particles. Such particle size distribution may be achieved, for example, by combining two sets of particles, wherein a first set consists essentially of particles in one size range (e.g., a coarser size range) and a second set of particles consists essentially of particles in a second size range (e.g., finer particles). The particle size distribution within each set of particle size range is typically such that the set has a modal particle size (which may be expressed either in terms of mesh or particle diameter) which represents the size or size range having the greatest concentration of particles. The relative absence of particles having sizes between those of the smaller particles and those of the larger particles can be advantageous in facilitating complete and rapid response to forces causing tire imbalance in conjunction with force equalizing of a tire/wheel assembly to provide sufficient correction of radial and lateral force variations. The applicant's co-pending U.S. Provisional Application Serial No. 60/133,775, entitled Composition for Equalizing Radial and Lateral Force Variations at the Tire/Road Footprint of a Pneumatic Tire, which is hereby incorporated by reference, describes these material characteristics.

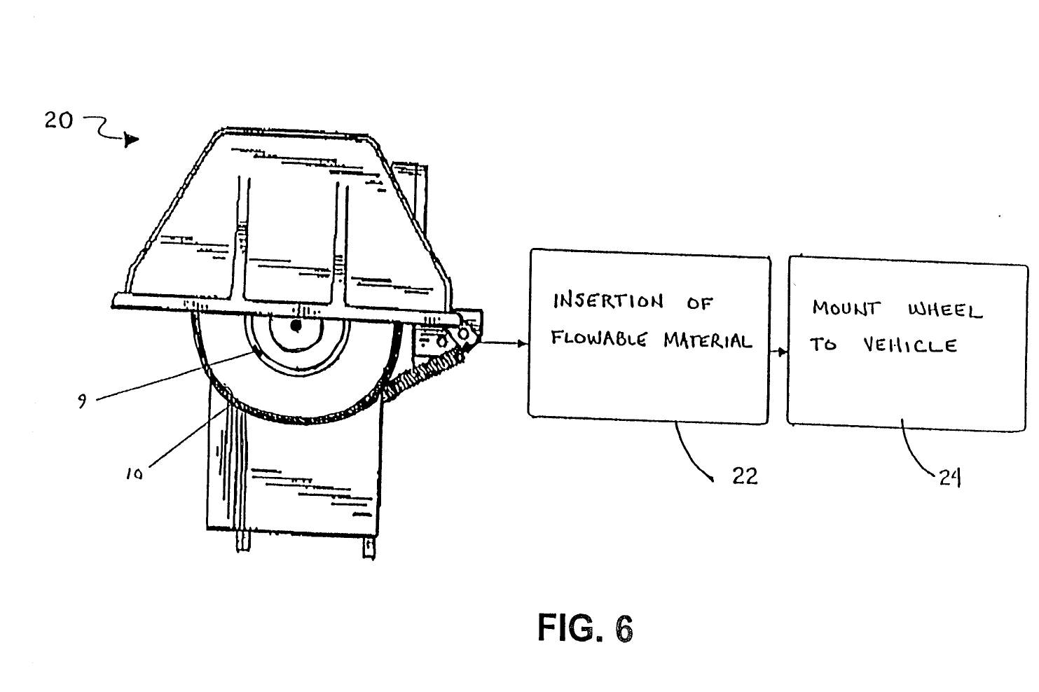

Turning now to FIG. 6, the method according to the preferred embodiment of the invention as shown, wherein a tire balancing apparatus 20 is shown with a tire/wheel assembly 10 mounted thereon. The apparatus 20 is a conventional wheel balancing system, which allows a tire/wheel assembly 10 to be mounted on a hub (not shown) and rotated at varying speeds to determine whether imbalances exist within the tire/wheel assembly 10 in an unloaded condition. Based upon the results of the balancing test, one or more weight adjusting means such as clip-on lead weights 9 may be used to correct for determined imbalances. The method according to the invention provides a predetermined amount of a movable material, which in the preferred embodiment is a particulate material as described above, which is selectively placed on the interior of the tire 11 at 22. As previously described, introduction of the flowable material at 22 may occur prior to mounting of the tire/wheel assembly 10 on the balancing machine 20, or could be performed while the assembly 10 is mounted on the machine 20 or thereafter. Subsequent to introduction of the flowable material at 22, the tire/wheel assembly 10 is then mounted to a vehicle at 24. The method according to the invention provides for compensation of radial and lateral force variations at the tire/road footprint during operation of the vehicle.

The effectiveness of the present invention and the utilization of the particle mixture 20 to equalize force variations of a tire/wheel assemblies was tested using a variety of different tire sizes and simulated vehicle weights by running the tires against a 67″ dynamometer and recording the vibration of the tire/wheel assembly using triaxial accelerometers. The tables below show a comparison of test results showing radial force measurements. The baseline for comparison purposes was a tire/wheel assembly balanced using a standard two-plane balance and a second tire/wheel assembly using a standard single plane balance. A third tire was a single plane balanced tire/wheel assembly and had 1.25 ounces of an amount of 20-40 mesh pulverulent synthetic plastic material particle mixture inserted into the tire/wheel assembly. As to the different methods of balance, it is commonly known that dual plane balance method is preferable to the single plane balance. A tire/wheel assembly is dynamically balanced when the centerline of the weight mass of the tire/wheel assembly is in the same plane as the centerline of the wheel. The addition of lead balance weights to an unbalanced tire/wheel assembly at specified locations of the wheel rim adjusts the centerline of the weight mass of the tire/wheel assembly to the same plane as the centerline of the wheel resulting in a balanced assembly. It is advantageous to use the two-plane method as weights can be added on both sides of the rim to balance the tire/wheel assembly and allows greater flexibility in obtaining a “perfect” balance. Therefore, in reviewing the results, specific improvements are compared to both methods of balancing, with the understanding that additional improvement in test results may be possible if the test tire/wheel assembly was balanced using the dual plane method of balancing. The vibration typically is most severe at highway speeds. Although the test ran at lower speeds, only the higher speeds 60-80 are reported due to the insignificant vibrations at lower speeds, especially for passenger vehicles. The radial forces shown represent the first harmonic.

### TEST RESULTS

Mercury Tracer - RR position - P185/60R14

| | Radial Force (g) | | | Reduction (%) | |
|---|---|---|---|---|---|
| | Dual | Single | | | Single vs. |
| | Plane | Plane | Single Plane | Dual vs. | Single and |
| Speed | Balance | Balance | Balance and | Single and | 20/40 |
| (MPH) | Only | Only | 20/40 pulv. | 20/40 pulv. | pulv. |
| 60 | 0.000004 | 0.000066 | 0.000031 | (675) | 53.0 |
| 70 | 0.000287 | 0.000286 | 0.000014 | 95.1 | 95.1 |
| 80 | 0.001640 | 0.002033 | 0.000132 | 91.9 | 93.5 |

Mercury Tracer - RR position - P185/60R14

| | Radial Force (g) | | | Reduction (%) | |
|---|---|---|---|---|---|
| | Dual | Single | | | Single vs. |
| | Plane | Plane | Single Plane | Dual vs. | Single and |
| Speed | Balance | Balance | Balance and | Single and | 20/40 |
| (MPH) | Only | Only | 20/40 pulv. | 20/40 pulv. | pulv. |
| 60 | 0.000012 | 0.000109 | 0.000069 | (475) | 36.9 |
| 70 | 0.000195 | 0.000240 | 0.000018 | 90.8 | 92.5 |
| 80 | 0.001078 | 0.002070 | 0.000094 | 91.3 | 95.4 |

Ford F250 - LF position

| | Radial Force (g) | | | Reduction (%) | |
|---|---|---|---|---|---|
| | Dual | Single | | | Single vs. |
| | Plane | Plane | Single Plane | Dual vs. | Single and |
| Speed | Balance | Balance | Balance and | Single and | 20/40 |
| (MPH) | Only | Only | 20/40 pulv. | 20/40 pulv. | pulv. |
| 60 | 0.005481 | 0.006067 | 0.004802 | 12.4 | 20.8 |
| 70 | 0.022560 | 0.025730 | 0.024183 | (7.1) | 6.0 |
| 80 | 0.182134 | 0.234755 | 0.159310 | 12.5 | 32.1 |

The test results show that a significant improvement is available when balancing is combined with the insertion of a particle mixture into the tire/wheel assembly. Therefore the improvement shown is in addition to that obtained by balancing the tire/wheel assembly.

Finally, it is important to reiterate that the resultant radial and lateral force variations encountered at the tire footprint may be caused by a variety of sources including, but not limited to, imbalance of the tire/wheel assembly, runout of the wheel and/or tire, irregularities in the structure of the tire, brake drag, wheel misalignment, road disturbances, worn linkages, etc. Although the present invention has been described above in detail, the same is by way of illustration and example only and is not to be taken as a limitation on the present invention. Accordingly, the scope and content of the present invention are to be defined only by the terms of the appended claims.

What is claimed is:

1. A method of reducing vibrations in a tire/wheel assembly comprising the steps of:
a) providing a tire/wheel assembly;
b) dynamically balancing said tire/wheel assembly on a tire/wheel balancing machine using at least one fixed weight to compensate for any vibrations due to imbalance in said tire/wheel assembly; and
c) providing an amount of a flowable material into an air chamber of said tire/wheel assembly wherein said flowable material moves along an interior surface of said tire to reduce vibrations caused by factors other than imbalance during rotation of said tire/wheel assembly.

2. A method of compensating for radial and lateral force variations in a pneumatic tire mounted on a vehicle comprising the steps of:
a) providing a tire/wheel assembly for use on a vehicle;
b) balancing the tire/wheel assembly on a tire/wheel balancing machine using at least one fixed weight attached to a flange of a wheel of the tire/wheel assembly; and
c) providing a generally dry flowable material within an air chamber of the tire/wheel assembly;
wherein the flowable material moves along an interior surface of the tire to reduce radial and lateral force variations during tire rotation; and
wherein steps b and c are performed regardless of order.

3. The method as defined in claim 2, wherein said dry flowable material is more thermally stable than the tire in which it is used under all tire operating conditions.

4. The method as defined in claim 2, wherein said flowable material is a powder.

5. The method as defined in claim 2, wherein the dry flowable material comprises particles formed from a polymeric resin.

6. The method as defined in claim 2, wherein the dry flowable material comprises glass beads.

7. The method as defined in claim 2, wherein the flowable material comprises a first portion of metallic spheres and a second portion of glass beads.

8. The method as defined in claim 2, wherein the dry flowable material comprises particles having a spherical shape.

9. A method of compensating for vibrations caused by radial and lateral force variations at the tire/road footprint of a pneumatic tire comprising the steps of:
a) rotating a tire/wheel assembly on a balancing machine to determine if any imbalance in the tire/wheel assembly exists;
b) applying a fixed weight, as needed, for selective application to the tire/wheel assembly to compensate for any imbalance in the tire/wheel assembly; and
c) inserting an amount of a substantially dry flowable material into an air chamber of the tire/wheel assembly wherein the dry flowable material moves along an interior surface of said tire to reduce the radial and lateral force variations during tire rotation.

10. The method as defined in claim 9, wherein said amount of dry flowable material is directly related to the amount of said imbalance compensated for during said balancing step.

11. The method as defined in claim 9, wherein said amount of dry flowable material is directly related to the size of said tire.

12. A method of compensating for radial and lateral force variations in a pneumatic tire mounted on a vehicle comprising the steps of:
a) providing a tire and a wheel for use on a vehicle wherein the tire and wheel are of a size less than or equal to 19.5 inches;
b) inserting a flowable material onto an interior surface of said tire;
c) mounting said tire on said wheel to form a tire/wheel assembly;
d) inflating said tire/wheel assembly to a specified pressure;
e) balancing said tire/wheel assembly on a balancing machine by applying at least one fixed weight to a flange of the wheel;
f) mounting said tire/wheel assembly on a vehicle; and
wherein said flowable material moves along said interior surface of said tire to reduce radial and lateral force variations during tire rotation;
wherein step b is performed after any step.

13. A method of reducing vibrations in a tire/wheel assembly comprising the steps of:
a) providing a tire/wheel assembly;
b) balancing said tire/wheel assembly on a tire/wheel balancing machine to compensate for any vibrations due to imbalance in said tire/wheel assembly; and
c) providing an amount of a flowable material into an air chamber of said tire/wheel assembly wherein said flowable material moves along an interior surface of said tire to reduce vibrations caused by factors other than imbalance during rotation of said tire/wheel assembly.
